(19) United States
(12) Patent Application Publication
(10) Pub. No.: US 2015/0222862 A1
(43) Pub. Date: Aug. 6, 2015

(54) CAMERA APPARATUS AND METHOD FOR REMOTELY CONTROLLING ELECTRONIC DEVICES

(71) Applicant: Honest Technology Co., Ltd, Daejeon (KR)

(72) Inventor: Soo Woo Lee, Daejeon (KR)

(21) Appl. No.: 14/686,739

(22) Filed: Apr. 14, 2015

Related U.S. Application Data
(63) Continuation-in-part of application No. PCT/KR2013/010028, filed on Nov. 6, 2013.

(30) Foreign Application Priority Data
May 22, 2013 (KR) 10-2013-0057483

(51) Int. Cl. H04N 7/18; H04N 5/225; H04N 5/232

(52) U.S. Cl. CPC H04N 7/183; H04N 5/23206; H04N 5/2256

(57) ABSTRACT

A networked camera for controlling electronic devices is provided. The camera includes a camera module for obtaining images, a remote control module for generating remote control signals for electronic devices, and an orientation module for controlling orientation of the remote control module. The remote control module includes an IR (infrared) beam emitter for generating IR remote control signals. In response to a control command from a user device, the camera identifies a target electronic device, an orientation associated with the target electronic device, and a code associated with the target electronic device based on the control command. The camera changes orientation of a remote control module toward the target electronic device using the identified orientation and transmit an IR control signal using the identified code. Then, in response to that transmitted IR control signal, the target electronic device executes one or more functions that correspond to the control command.

### BACKGROUND

The present disclosure relates to a networked camera or an IP camera, and more particularly, to controlling electronic devices using the IP camera.

Internet Protocol (IP) cameras are commonly used for surveillance purpose and monitor indoor and outdoor areas. The IP camera is installed at a location where surveillance is necessary. A user can connect to the IP camera by connecting to a communication server with a personal terminal (e.g., smartphone, desktop PC, laptop PC, etc.) via the Internet. The user can then control pan/tilt or zoom functions of the IP camera, or view images captured through the IP camera on a real-time basis remotely.

### SUMMARY

According to various aspects of the invention, an IP camera has a remote-control capability to acquire image data of an area of interest and remotely control electronic devices that are located within in the area of interest. The IP camera provides simplified procedures for inputting data that the IP camera will need to learn and process for the remote control feature of electronic devices.

One aspect of the present invention provides a remote control system for controlling a target electronic device with a camera apparatus. The remote control system includes a user interface for installing on a user computing terminal, a camera apparatus connected to the user computing terminal via a network such that the camera apparatus is configured to transmit images/videos to the computing terminal for viewing via the user interface and that the camera apparatus is configured to receive user commands submitted via the user interface for controlling the camera apparatus.

The camera apparatus can include an IR receiver configured to receive IR beam patterns from an external remote controller and can be programmed to learn the IR beam patterns received at the IR receiver. The camera practice can include a processing module for processing data received IR beam patterns for generating codes to be stored in memory of the camera apparatus, in association with the target electronic device and/or an orientation in which IR emitter of the camera apparatus is aligned with the target electronic device.

In certain embodiments, IR beam patterns for controlling the target electronic device and/or corresponding codes of the IR beam patterns can be downloaded from an external computing device via a communication module of the camera apparatus rather than via the IR receiver of the camera apparatus. To download the IR beam patterns and/or the corresponding codes from the external computing device, the camera apparatus can send a request including identification of the target device and/or identification of a specific function of the target device to the external computing device via the communication module.

Another aspect of the present invention provides a method of operating a camera apparatus for controlling a target electronic device. The method comprises establishing a communication channel with a user terminal via Internet module of the camera apparatus; receiving a selection of the target electronic device from a user terminal connected to the camera apparatus; receiving a confirmation of a first orientation from the user terminal; storing, in memory of the camera apparatus, the first orientation in association with the target electronic device; receiving an identification of a first function of target electronic device the from the user terminal; storing, in the memory, a first code corresponding to the first function in association with the target electronic device; subsequently, receiving a first user command for controlling the first function of the target electronic device; in response to the first user command, retrieving the first orientation and the first code from the memory; changing orientation of an IR emitter of the camera apparatus to the first orientation, if needed; and emitting a first IR beam pattern corresponding to the first user command from the IR emitter for controlling the first function of the first electronic device.

The method of operating a camera apparatus can further include learning the first IR beam pattern when the IR receiver receives the first IR beam pattern while the remote control feature is being set up for the first electronic device, and upon receipt of the first IR beam pattern, processing the received first IR beam pattern for generating the first code to store in the at least one data entry in association with the first electronic device or the first orientation. The method of operating a camera apparatus can also include receiving the first code corresponding to the first IR beam pattern from an external computing device connected via the Internet module.

The method of operating a camera apparatus can include determining if it is needed to change the IR emitter's orientation to the first orientation, wherein when the camera apparatus determines that the IR emitter's orientation needs to change, causing the orientation module to change the IR emitter's current orientation to the first orientation or to an orientation within a predetermined tolerance from the first orientation.

According to embodiments of the present invention, it is possible to obtain an enhanced efficiency of energy management while externally controlling electronic devices remotely without an additional communication network between a network device and the electronic devices by using one of a plurality of IR LEDs amounted to a surveillance IP camera as an IR remote-control for controlling the electronic devices.

A technical aspect of the present invention is to provide a method for controlling an electronic device using an IP camera with a wireless remote controlling function which is capable of monitoring an area of interest based on images acquired from the IP camera while concurrently controlling the electronic device at a remote distance by using at least one of a plurality of IR LEDs mounted to the surveillance IP camera as an IR remote control to control the electronic device.

Another technical aspect of the present invention is to provide a method for controlling an electronic device using an IP camera with a wireless remote controlling function which can simplify a procedure of registering data to be learned for controlling the electronic device using the IP camera system at a remote distance through a user terminal.

According to an embodiment of the present invention, a method for controlling an electronic device using an Internet protocol (IP) camera with a wireless remote controlling function is provided. The method may include steps of: in response to a request signal for learning a remote control signal and a remote control signal for learning that is received via the IP camera, learning a remote control signal of the electronic device by matching (associating) the received remote control signal for learning with a remote control menu item, by the IP camera, receiving a learned control signal for the electronic device from the user terminal and registering the same, and in response to a remote control signal of the electronic device from the user terminal, controlling by the IP camera operation of the electronic device based on the learned information.

The process of learning at the user terminal may include receiving a learning request signal, receiving a signal to select an electronic device as a target device of learning, displaying on a screen a remote control information and a remote control menu item corresponding to the electronic device for which the learning is requested, transmitting control signal for an electronic device to the IP camera according to a user input signal, determining whether or not the electronic device operates in accordance with the user input signal based on an information acquired by the IP camera, and when the electronic device is determined to be operating in accordance with the user input signal, downloading a corresponding remote control signal information from outside.

Further, the process of learning at the user terminal may include receiving a learning request signal, receiving a signal to select an electronic device requested for learning, displaying on a screen the remote control menu item necessary for controlling the electronic device selected for learning, receiving a plurality of remote control signals for learning one after another at the IP camera, assigning an identification code for each of the received remote control signal and displaying the identification code on the screen, transmitting, in response to a user manipulation signal, at the IP camera, the remote control signal for which the identification code is assigned such that the electronic device is controlled, and matching the identification code with the remote control menu item displayed on the screen in response to a user manipulation signal.

Further, the process of learning at the user terminal may include receiving a learning request signal, receiving a signal to select a target electronic device, receiving a remote control signal to be learned via the IP camera, and registering a menu name corresponding to the received remote control signal in accordance with a user manipulation signal.

Further, the process of learning at the user terminal may additionally include receiving a signal to select an IP camera, and receiving pan/tilt information of the selected IP camera and registering the same in association with the identification information of a target electronic device.

The process at the user terminal of receiving the signal to select target electronic device for learning may include acquiring a shape information of the target electronic device from a camera captured image and causing the electronic device to be automatically identified and selected using a pattern matching between the acquired shape information of the electronic device and a pre-set shape information.

Further, the method may include controlling operation of the IP camera in accordance with a control request from the user terminal and transmitting an obtained image to the user terminal, receiving a remote control signal from the user terminal, reading and obtaining an electronic device control signal by matching the received remote control signal with the learned information, and then controlling the operation of the electronic device in accordance with the obtained control signal.

Further, the process of controlling the operation of the electronic device, at the IP camera, may include receiving the remote control signal from the user terminal, reading and obtaining an IP camera actuation control signal and an electronic device control signal by matching the received remote control signal with the learned information, controlling actuation of the IP camera in accordance with the recovered IP camera actuation control signal, and controlling the operation of the electronic device in accordance with the obtained electronic device control signal.

Also, the method may include transmitting, at the IP camera, information about an operating electronic device based on an acquired image information or sound information to the user terminal, and the IP camera may calculate a pan/tilt information of the IP camera based on location information of a control target electronic device and the IP camera and control the operation of the IP camera based on the calculated pan/tilt information of the IP camera.

Further, the IP camera may perform the steps of acquiring a sound signal outputted from the electronic device requested for controlling through a microphone, calculating a location of the electronic device requested for controlling, angle information between the electronic device requested for controlling, and the IP camera based on the sound signal acquired through the microphone, calculating a pan/tilt information of the IP camera based on the location, the angle information as calculated, and controlling the actuation of the IP camera in accordance with the calculated pan/tilt information of the IP camera.

An aspect of the present invention is to provide a camera apparatus for controlling an electronic device. The camera apparatus includes an Internet module configured to communicate with at least one device connected to the Internet, a camera module comprising a lens and configured to capture images received through the lens, a remote control module comprising an infrared (IR) emitter configured to emit IR beams for controlling one or more electronic devices, an orientation module configured to change the IR emitter's orientation relative to the one or more electronic devices, and a memory configured to store data for use in controlling the one or more electronic devices.

In certain embodiments of the present invention, the camera apparatus is programmed for setting up a remote control feature for a first electronic device. The camera apparatus is operable to determine a first orientation for use in orienting the IR emitter toward the first electronic device; to store, in the memory, the first orientation in association with the first electronic device; and to store, in the memory, a first code corresponding to a first IR beam pattern for controlling a first function of the first electronic device, in association with either or both the first electronic device and the first orientation.

In certain embodiments of the present invention, the camera apparatus is programmed for executing the remote control feature. More specifically the camera apparatus is programmed to retrieve the first orientation and the first code from the memory in response to a first user command for controlling the first function; to cause the orientation module to change the IR emitter's orientation to the first orientation, if needed; and to cause the IR emitter to emit the first IR beam pattern corresponding to the first code.

In certain embodiments of the present invention, the camera includes an IR receiver for receiving IR beam patterns from an external remote controller. While the user set up remote control feature of the camera, the camera can learn IR beam patterns for controlling electronic devices using the IR receiver. When IR beam patterns are received at their IR receiver, the camera processes the received beam patterns to produce codes representing the received IR beam patterns. A code representing an IR beam pattern can be stored in the camera in association with identification of an electronic device, a function of the electronic device, and/or orientation corresponding to the electronic device in a memory of the camera. In certain embodiments of the present invention, the camera is configured to receive codes corresponding to IR beam patterns from an external computing device connected to the camera.

In certain embodiments, the camera apparatus sends images/videos captured by the camera module to a user interface installed on a computing terminal connected to the camera apparatus via the Internet module such that a user can monitor surroundings of the camera apparatus while configuring and/or operating the camera apparatus. Accordingly, a user can send a control signal for changing the IR emitter's orientation from the user interface while viewing images/videos. The user can confirm, via the user interface, an orientation associated with an electronic device while viewing the images/videos from the camera apparatus.

In certain embodiments, when an orientation is determined for use in orienting an IR emitter toward an electronic device, prior to associating with the electronic device, the camera apparatus is further programmed to confirm that at the determined orientation the IR emitter is aligned with the electronic device such that the electronic device responds to IR beam patterns emitted from the IR emitter. The camera, in the determined orientation, sends an IR beam pattern and monitors operation of the electronic device using sound, image, or video capture by the camera before and after transmitting the IR beam pattern. For example, when the camera transmits an IR beam pattern corresponding to turning-on function of a radio, the camera can compare sound levels obtained before and after transmitting the IR beam patent and verify that the radio was turned on in response to the IR beam pattern from the camera.

In some embodiments, the camera apparatus can identify an electronic device from an image captured by the camera module and initiate a setup mode for setting up remote control feature of the camera regarding the identified electronic device. For example, when the camera stores or has access on shape information of a specific model of TV, the camera identifies the specific model of TV using image processing technique and initiates setup mode for configuring remote control features of the camera without receiving selection of the specific model from users.

The camera apparatus can determine whether or not it needs to change the IR emitter's orientation to the first orientation. The camera apparatus may determine that the

IR emitter's orientation does not need to change when the IR emitter's current orientation is within a predetermined tolerance from the first orientation.

The camera apparatus can determine whether or not it needs to change the IR emitter's orientation to the first orientation. When the camera apparatus may determine that the IR emitter's orientation needs to change, the camera apparatus controls its orientation module to change the IR emitter's current orientation to the first orientation or within a predetermined tolerance from the first orientation.

### BRIEF DESCRIPTION OF THE DRAWINGS

The foregoing aspects and many of the attendant advantages of this disclosure will become more readily appreciated by reference to the following detailed description, when taken in conjunction with the accompanying drawings, wherein:

FIG. 1 illustrates an IP camera system according to an embodiment of the present invention.

FIG. 2 illustrates a perspective view of the IP camera of FIG. 1.

FIG. 3 is a block diagram of components of the IP camera of FIG. 1.

FIG. 4 is a flowchart of a learning process of an IP camera system according to an embodiment of the present invention.

FIG. 5 is a flowchart of another learning process of an IP camera system according to an embodiment of the present invention.

FIG. 6 is a flowchart of another learning process of an IP camera system according to an embodiment of the present invention.

FIG. 7 is a flowchart of another learning process of an IP camera system according to an embodiment of the present invention.

FIG. 8 is a flowchart of remotely controlling an electronic device using an IP camera system according to an embodiment of the present invention.

FIG. 9 is a flowchart of remotely controlling an electronic device using an IP camera system according to an embodiment of the present invention.

FIG. 10 illustrates an IP camera system according to an embodiment of the invention.

FIG. 11 is a flowchart of another learning process of an IP camera system according to an embodiment of the invention.

FIG. 12 is a flowchart of remotely controlling electronic devices using an IP camera according to an embodiment of the invention.

FIG. 13 illustrates a data structure according to an embodiment of the invention.

### DETAILED DESCRIPTION OF EMBODIMENTS

To fully understand the purpose achieved by the embodiments of the present invention and operational advantages thereof, reference is made to the appended drawings illustrating embodiments of the present invention and also to the contents shown in the drawings.

### IP Camera System

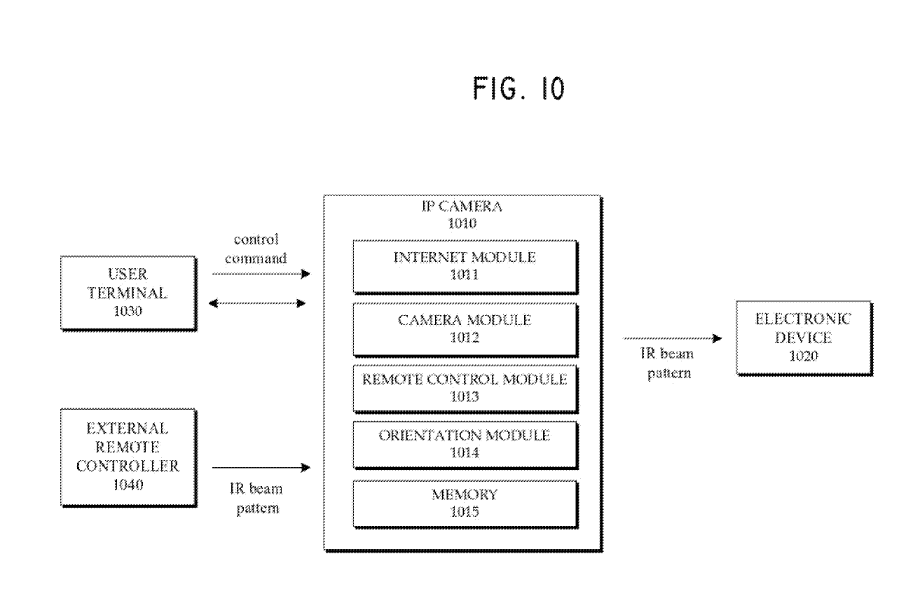

FIG. 10 illustrates an IP camera system according to an embodiment. The IP camera system includes an IP camera 1010, a user terminal 1030, an electronic device 1020, a remote control device 1040 for the electronic device. The IP camera 1010 includes an internet module 1011, a camera module 1012, a remote control module 1013, an orientation module 1014, and a memory 1015.

### Operation of IP Camera System

According to embodiments, the IP camera system allows a user remotely watch on the user terminal 1030 images of the electronic device 1020 that are captured by the IP camera. Further, the IP camera system further allows the user remotely control the operation of the electronic device 1020 via the user terminal 1030 and IP camera 1010. For example, at the user's command, the IP camera 1010 emits IR control signals to the electronic device 1020 for certain operation. In embodiments, the IP camera system provides learning processes for learning IR control signals of the remote control device 1040 for the control of the electronic device 1020. Further, in embodiments, the IP camera system provides adjusting the orientation of the IP camera 1010 such that its IR control signals are directed to the electronic device 1020.

### Learning Process

According to embodiments, user can initiate a process of learning a remote control signal for controlling a first function of the electronic device 1020. As a user selects a menu via an interface displayed on the user terminal 1030, the user terminal send a command that includes a first information which identifies the first function and/or the electronic device 1020. In response to the command, the camera 1010 prepares obtain a remote control signal via a receiver in the remote control module 1013. The camera processes the obtained remote control signal for generating a code corresponding to the obtained remote control signal. The camera stores the code, in the memory 1015, in Association with the first function and/or the electronic device 1020.

In embodiments, while a user monitors images/video from the camera 1010, the user can send a confirmation when the electronic device 1020 is visible in the images/video from the camera 1010. The confirmation includes identification of the electronic device 1020. In response to the confirmation, the camera 1010 can recognizes its current orientation using one or more sensors associated with the orientation module 1014, and stores the current orientation in association with the identification of the electronic device 1020. The orientation stored in a associate with the electronic device 1020 can be retrieved for adjusting the camera's orientation prior to transmit a remote control signal toward the electronic device 1020.

### Remote Control of Electronic Device

According to embodiments, a user sends a command for controlling a first function of the electronic device 1020 using an interface of the user terminal 1030. The command includes a first information that can identify the first function and/or the electronic device 1020. Using the first information in the command, the camera 1010 retrieves a first orientation and a first code associated with the first function of the electronic device 1020 from the memory 1015. The camera recognizes its current orientation using one or more sensors associated with the orientation module 1014. The camera determines whether or not it is needed to change orientation of the remote control module 1013, using the current orientation and the first orientation (or tolerance of the first orientation) retrieved from the memory 105. When the camera determines that it needs to change orientation of the remote control module 1013, the camera generates a control signal for the orientation unit 1014 based on the current orientation and/or the retrieved first orientation. After changing the orientation, the camera generates a remote control signal for controlling the first function using the retrieved first code.

### User Terminal

The user terminal 1030 communicates with the IP camera 1010 and for controlling an electronic device 1020. The user terminal 1030 is a computing device and includes an input module for receiving user's interaction, a display module for displaying images/videos obtained from the camera, and a communication module for communicating with the camera via a network. Various types of computing devices including mobile phones, notebook computers, tablets, and PDAs can be used as the user terminal.

In certain embodiments of the present invention, the user terminal provides a user interface for controlling the electronic device via the camera. A user can input information via the provided interface to configure/control the camera and to monitor operation of the electronic device with sounds, images, and videos provided by the camera. The user interface can be provided by a computer executable program installed on the user terminal. In certain embodiments, the computer executable program can be a mobile application on a smartphone or a web browser in which a webpage to control the camera is rendered.

In certain embodiments of the present invention, the user interface stores association among items in the interface, target functions, and target devices. When a user selects an item splayed on the user terminal, the user terminal retrieves information regarding associated target functions and/or target devices, generate a communication based on the retrieves information, and the generated communication as a control command for the camera.

### Electronic Device

The electronic device 1020 is a device that can be controlled by a remote control signal. Various electronic devices including a remote control signal receiver can be the electronic device 1020. For example, televisions, air conditioners, pet feeder, illumination devices, and music players with IR remote control features can be the electronic device 1020.

The electronic device has a predetermined set of remote control signals for controlling functions of the electronic device. The predetermined set of remote control signals can be stored on an external system computing device that is connected to the user terminal and/or the camera. In response to selection of a target electronic device, a predetermined set of remote control signals can be transmitted, from the external computing device, to the user terminal and/or the camera such that the camera can generate one or more remote control signals from the predetermined set in response to a user's request for activating one or more functions of the target electronic device that corresponds to the one or more remote control signals.

### Remote Control for Electronic Devices

The external remote controller 1040 is a remote control that stores one or more remote control signals of the electronic device. For example, the external remote controller can be a traditional remote control using IR signals (beam patterns) to control a TV.

The user can teach the remote control signals of the electronic device using the external remote controller. In certain embodiments, the user can send a command to the camera for initiating a learning process of remote control signals associated with the electronic device. When the camera is ready to learn remote control signals the user manipulates the external remote controller to send remote signatures to a receiver of the camera.

### Camera

The camera 1010 includes an Internet module 1011, a camera module 1012, a remote control module 1013, an orientation module 1014, and a memory 1015. In certain embodiments, the camera is a surveillance camera connected to Internet for providing new time images and videos its surroundings.

### Internet Module

The camera can include a communication module (Internet module 1011) for exchanging data with the user terminal via wired/wireless networks. The camera is operable to exchange information, via the communication module, with external devices including the user terminal and/or a server storing information for controlling the electronic device. In certain embodiments the camera is connected to the Internet and the communication module can be called as Internet module.

### Camera Module

The camera includes a camera module 1012. The camera module is operable to capture images and videos with an optical system including one or more lenses. The camera module includes a sensor for capturing images, a processor for processing images, and an interface for providing images to other modules of the camera or to external devices. In certain embodiments, the camera module is installed in the body of the camera and aligned in association with the remote control module such that the camera module can obtain images of electronic devices to which a remote control signal form the remote control module is directed.

The camera module can also include a sensor for capturing sounds. For example, the camera module can include a microphone to obtain sounds from surroundings of the camera. Sound signal obtained by the camera module can be used to check/verify operation of electronic devices before or after the electronic devices are controlled by a remote control signal from the camera.

In certain embodiments, information captured by the camera module can be used to monitor operations of the electronic devices before and after transmitting remote control signals for controlling the electronic devices. The camera compares operation status before and after transmitting a remote control signal and determine whether a target electronic device responded to the remote control signal.

### Remote Control Module

The camera includes a remote control module 1013 for transmitting/receiving remote control signals. The remote control module includes an emitter configured to generate a remote control signal. For example, the remote control module includes an IR emitter component for transmitting IR remote control signal to the electronic device. The remote control module can generate a remote control signal (IR beam pattern) using a code, stored in the memory. The code includes information for generating the remote control signal at the remote control module. The code can be generated by processing a remote control signal received at the camera after learning process for remote control signals is initiated in the camera or can be obtained from an external server which stores close representing remote control signals of target electronic devices.

The remote control module includes a receiver configured to receive a remote control signal from external devices. As explained above, the user can teach remote control signals by manipulating the external remote controller when the camera is ready to learn remote control signals corresponding to the electronic device.

In certain embodiments, a receiver for receiving remote control signals can be a sensor distinct from an image capturing sensor of the camera. While IR remote control signals can be identified by processing images obtained by the camera module, processing of images to obtain IR signal would cost substantial amount of processing power and sophisticated programs to identify IR signal patterns. Instead of using a costly image processing procedures, the camera can include a commercialized IR receiver module in addition to the camera module to save cost for implementing cameras according to the embodiments of the present invention.

While IR remote control signal is a good example, the remote control module can handle remote control signals that have different frequency bands from IR signals.

### Orientation Module

The orientation module 1014 is a module configured to change orientation of the remote control module 1013. The orientation module includes actuators for changing positions and directions of the remote control module. The orientation module can include controllers of the actuators and/or mechanisms associated with them actuators.

When the remote control module is fixed in a body of the camera, the orientation module is operable to change positions and directions of the camera's body for changing positions and directions of the remote control module. By changing orientation of the remote control module, remote control signals like IR beams can be directed to a target electronic device that a user wants to control with the remote control module of the camera.

In certain embodiments, the remote control module (IR emitter) and the camera module (optical system) are fixed in a single piece body and configured to change their orientation as the single piece body changes its orientation.

### Memory

In embodiments, the memory 1015 is a data storage that stores information for controlling the electronic devices. The memory may be a single piece storage device or a multiple devices connected together.

Electronic Device Stored with Orientation of Camera

In embodiments, the memory stores data about the electronic device including identification of the electronic device, functions of the electronic device, and codes representing remote control signals associated with the electronic device. These data can be associated with one other, in the memory, such that the camera is operable to identify and generate a remote control signal corresponding to a specific function of the electronic device.

The camera also maintains data regarding an orientation in which the remote control module is aligned with the electronic device. To deliver a remote control signal from the remote control module 1013 to the electronic device 1020, the camera needs to be in a position and/or a posture that would make the remote control module aligned with a remote control signal receiver of the electronic device. A desirable orientation (position) for transmitting a remote control signal to the electronic device can be confirmed by the user via an interface update user terminal 1030 while the user monitors images/video of the electronic device captured by the camera module 1012 via the interface. The camera can store a desirable orientation and its tolerance for each of target electronic devices, in the memory 1015, in association with a target electronic device, a specific function of the target electronic device, or a code representing a remote control signal for controlling the specific function. A desirable orientation can be stored in a form of position, dislocation, and/or angles associated with one or more actuators that are configured to change position and/or postures of the remote control module (or the camera).

In certain embodiments, the camera stores relative positions between the camera and its surroundings objects including the electronic device. When a user moves the camera from a first position to a second position, the camera recognizes its surroundings objects at the second position, recognizes its movement from the first position to the second position, and update relative position between the camera and the electronic device at the second position based on the recognized movement. When the camera recognizes changes in relative position between the camera and the electronic device is updated, orientation of the camera for controlling the electronic device can be also updated based on the recognized changes.

In the memory, the camera maintains a data entry for each of target electronic devices. In the data entry, the camera stores association among identification of an electronic device, functions of the electronic device, remote control signals (IR beam patterns) for controlling the functions, codes representing the remote control signals, a menu item that can be displayed in an interface on the user terminal, and desirable orientations of the remote control module for delivering remote control signals to the electronic device. In certain embodiments, the camera can maintain two or more data entries associated with each other for a target electronic device. Association among identification of a target electronic device, functions of the target electronic device, remote control signals (IR beam patterns) for controlling the functions, codes representing the remote control signals, and desirable orientations of the remote control module can be also maintained across the two or more data entries associated with one another.

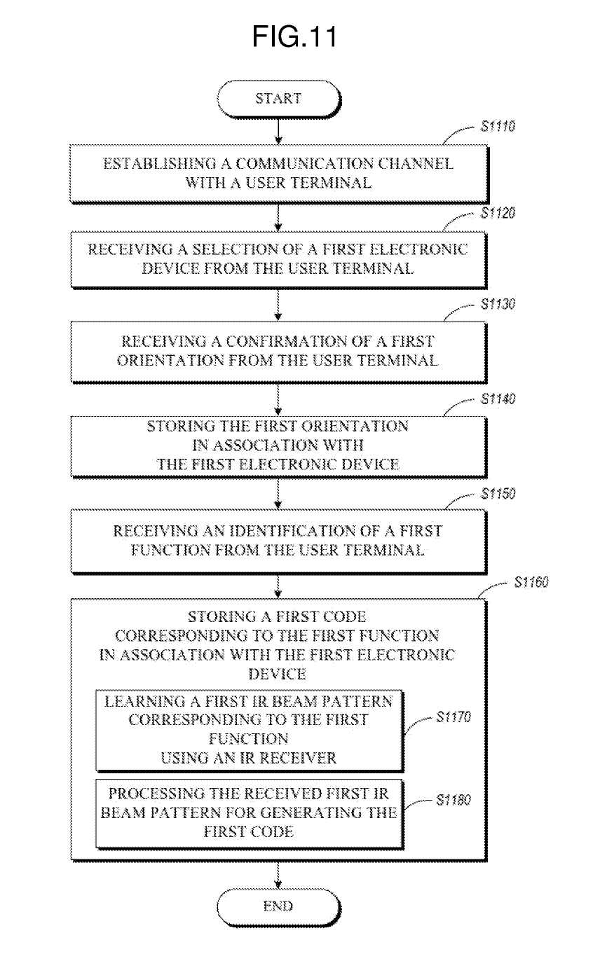

FIG. 11 is a flowchart illustrating a method for controlling devices conducted by a networked camera that includes a remote control module. The method comprises establishing a communication channel with a user terminal; receiving a selection of a first electronic device from the user terminal; receiving a confirmation of a first orientation from the user terminal; storing the first orientation in association with the first electronic device; receiving an identification of a first function from the user terminal; storing a first code corresponding to the first function in association with the first electronic device.

### Establishing a Communication Channel (S1110)

The camera 1010 can establish a communication channel with the user terminal or other external computing devices via the Internet module 1011. (S1110) Using the established communication channel, the camera can provide images/videos captured to the user terminal and the user terminal can provide control command to configure and control functions of the camera. User interaction to control the functions of the camera can be conducted via an interface/application in stored on the user terminal.

### Receiving Selection of an Electronic Device (S1120)

When a user selects a target electronic device to be controlled via an interface on the user terminal, the camera receives information regarding selection of the target electronic device. (S1120) In response to a selection of the target electronic device, the camera can assign identification for the selected target electronic device and generate a data entry for the target electronic device. The data entry can be used for storing data that can be used for controlling the target electronic device and storing association between the data. For example, the data can include identification of a target electronic device, functions of the target electronic device, remote control signals (IR beam patterns) for controlling the functions, codes representing the remote control signals, and desirable orientations of the remote control module.

### Receiving Confirmation of an Orientation (S1130)

The user also can confirm a desirable orientation of the camera (and its remote control module) for transmitting a remote control signal to the target electronic device. (S1130) While monitoring images/videos from the camera at the user terminal, the user send control commands, via the established communication channel between the user terminal and the camera, to control orientation of the camera such that the remote control module of the camera is aligned with the target electronic device. For example, the user can confirm the desirable orientation when the target electronic device is at the center of the viewing angle of the camera (which may represent signal transmission angle of the remote control module) via an interface displayed on the user terminal.

In response to confirmation of the desirable orientation, the camera identifies its orientation using one or more sensors associated with the orientation module of the camera, and stores the identified orientation in a data entry associated with the target electronic device. The cameras orientation can be stored in a form of positions and/or angles associated with one or more actuators of the orientation module.

In certain embodiments, when a code for controlling a specific function of the target electronic device is available for the camera, the camera can verify a desirable orientation of the remote control module (or of the camera) using the code. The camera changes its position to the desirable orientation, generates a remote control signal at the remote control module using the code, captures sounds and/or images of its surroundings, and monitors operation of the target electronic based on the captured sounds and images. When it is determined that the target electronic device controls the specific function in response to the remote control signal, the camera can determine that the desirable orientation is valid.

### Storing an Orientation for Controlling an Electronic Device (S1140)

In response to a confirmation from the user (or a verification of the orientation by the camera), the camera can store a desirable orientation for controlling the target electronic device in a data entry, in the camera's memory, associated with the target electronic device. (S1140)

### Receiving Selection of a Function (S1150)

The user can select/specify the target device's function to be controlled with the camera via an interface/application on the user terminal. (S1150) For example, the user can select various functions of a TV including power-on, power-off, volume-up, etc.

In certain embodiments, in response to selection of the target device, the user terminal sends a request to an external server to obtain a list of controllable functions of the target electronic device. In response to the request, the external server provides a list of controllable functions of the target electronic device. In other embodiments, a database of controllable functions can be stored on the user terminal and a list of controllable functions of the target electronic device can be retrieved from the database inside the user terminal in response to a selection of the target electronic device.

In certain embodiments, selection of a controllable function of the target electronic device initiates a process for learning a remote control signal corresponding to the controllable function and obtaining a code representing the remote control signal.

### Storing a Code for Controlling a Function (S1160, S1170, S1180)

The camera is operable to store a code corresponding to a function of the target electronic device, in association with the target electronic device. (S1160)

In certain embodiments, in response to selection of the controllable function, the user terminal and/or the camera can send a request to an external server to obtain a code corresponding to the selected controllable function. The code includes information for generating, at the camera's remote control module, a remote control signal for controlling the selected function of the target electronic device. When the code corresponding to the selected control function is obtained from the external server, the code can be (transmitted to the camera and) stored in a data entry, of the camera's memory, in association with the controllable function and/or the target electronic device.

In other embodiments, a database including a predetermined set of codes representing remote control signals (IR beam patterns) can be established in the camera and/or the user terminal. In response to selection of a controllable function, a code that represents a remote control signal for controlling the selected function can be retrieved from the database without requiring a remote control signal received at the camera and further processing of the received remote control signal.

In other embodiments, a code representing a remote control signal can be generated by learning (receiving) a remote control signal at the camera. (S1170) When the camera is ready to receive a remote control signal corresponding to a selected function of the target electronic device, via the remote control module 1013 of the camera 1010, the user can manipulate the external remote controller 1040 to input a remote control signal remote control module 1013. When the camera receives a remote control signal from the external remote controller, the camera can process the received remote control signal to obtain a code representing the received remote control signal. (S1180) For example, the camera transforms the received remote control signal to the corresponding code. Part of processes for obtaining the code can be conducted by an external computing device, including the user terminal. For example, at least part of transformation from the received remote control signal to the corresponding code can be conducted by an external computing device. In certain embodiments, the camera may send a request for seeking a code corresponding to the received remote control signal (IR beam pattern) to an external computing device that stores association between codes and remote control signals.

While FIG. 11 illustrates a sequence of processes for implementing an embodiment of the present invention, orders of the processes can be modified for another embodiment of the present invention.

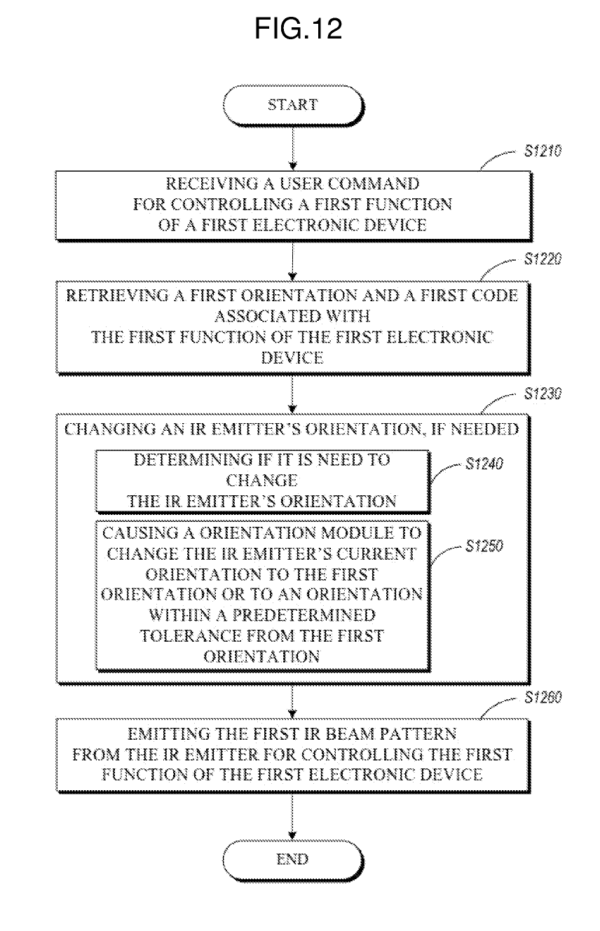

FIG. 12 is a flowchart illustrating a method conducted by a networked camera that includes a remote control module for controlling electronic devices. The method comprises receiving a user command for controlling a first function of the first electronic device; retrieving a first orientation and a first code associated with the first function of the first electronic device; changing an IR emitter's orientation if needed; emitting a remote control signal from the IR emitter for controlling the first function of the first electronic device. Changing the IR emitter's orientation can include determining if it is needed to change the IR emitter's orientation and causing an orientation module to change the IR emitter's current orientation to the first orientation or to an orientation within a predetermined tolerance from the first orientation.

### Receiving a User Command for Controlling a Function (S1210)

Via the Internet module 1011, the camera 1010 can receive a control command from user terminal (S1210). The control command includes identification of a target electronic device and/or identification of a target function of the target electronic device. The control command can be sent from the user terminal when the user selects an interface associated with the target function or when a predetermined condition for controlling the target function is met. For example, the user can set a condition for turning on an air-conditioner when temperature is higher than a predetermined criterion. The user terminal maintains one or more predetermined conditions for controlling the target electronic device and check periodically whether the one or more predetermined conditions are satisfied. As such, information available to the user terminal (time, location, temperature, etc.) can be a trigger for sending a control command to the camera for controlling functions of the target electronic device.

### Retrieving a First Orientation and a First Code (S1220)

In response to the control command from the user terminal, the camera retrieves a first orientation and a first code for controlling the target function of the target electronic device from the memory 1015 of the camera. (S1220) The first orientation is a desirable orientation in which a remote control signal generated by the camera can be transmitted to the target electronic device. The first code includes information for generating a remote control signal (IR beam signal) for controlling the target function at the remote control module 1013.

### Changing an IR Emitter's Orientation, If Needed (S1230)

When the camera retrieves the first orientation and the first code in response to the control command from the user terminal, the camera can change orientation of the remote control module (IR emitter) using the retrieved first orientation. (S1230) In certain embodiments, the camera can check its current orientation and tolerance for desirable orientations prior to changing its orientation using the desirable orientations stored in the memory.

### Determining if it is Needed to Change the IR Emitter's Orientation (S1240)

When a desirable orientation of the remote control module (IR emitter) is retrieved in response to a control command from the user, the camera can determine if it is needed to change orientation of the remote control module such that a remote control signal on the remote control module can be delivered to the target electronic device. (S1240) In certain embodiments, the camera identifies its current orientation from one or more sensors associated with the orientation module (actuators) of the camera, compares the current orientation with the desirable orientation for the target electronic device. When it is determined that the current orientation meets tolerance of the desirable orientation, the camera determines not to change its orientation before transmitting a remote control signal in response to the control command from user. When it is determined that the current orientation does not meet tolerance of the desirable orientation, the camera determines to change its orientation (the remote control module's orientation) prior to generate a remote control signal in response to the control command from user.

In certain embodiments, the camera check operation of the target electronic device after generating a remote control signal and, when operation of the target electronic device is different from an operation expected from the remote control signal (for example, the target electronic device is not responding), the camera determines to change its orientation and generate the remote control signal again.

### Causing an Orientation Module to Change the IR Emitter's Orientation (S1250)

When the camera determines it is needed to change orientation of the remote control module of the camera, the camera causes the orientation module to change the orientation using the retrieved first orientation. (S1250) To change the orientation using the retrieved first orientation, the camera recognizes a current orientation based on signals from one or more sensors associated with the orientation module and generate a driving signal for the orientation module for changing the orientation of the remote control module from the current orientation to the first orientation retrieved. While changing the orientation, the camera can consider tolerance for the first orientation.

### Emitting the IR Beam Patterns (S1260)

When the camera changes the orientation or determines the current orientation is curable for a emitting a remote control signal for controlling the target function of the target electronic device, the camera cause the remote control module (IR emitter) to generate a remote control signal using the retrieved first code. The first code contains information for generating a remote control signal that corresponds to the target function. For example the first code includes information to drive/activate an IR emitter for generating an IR beam pattern.

While FIG. 12 illustrates a sequence of processes for implementing an embodiment of the present invention, orders of the processes can be modified for another embodiment of the present invention.

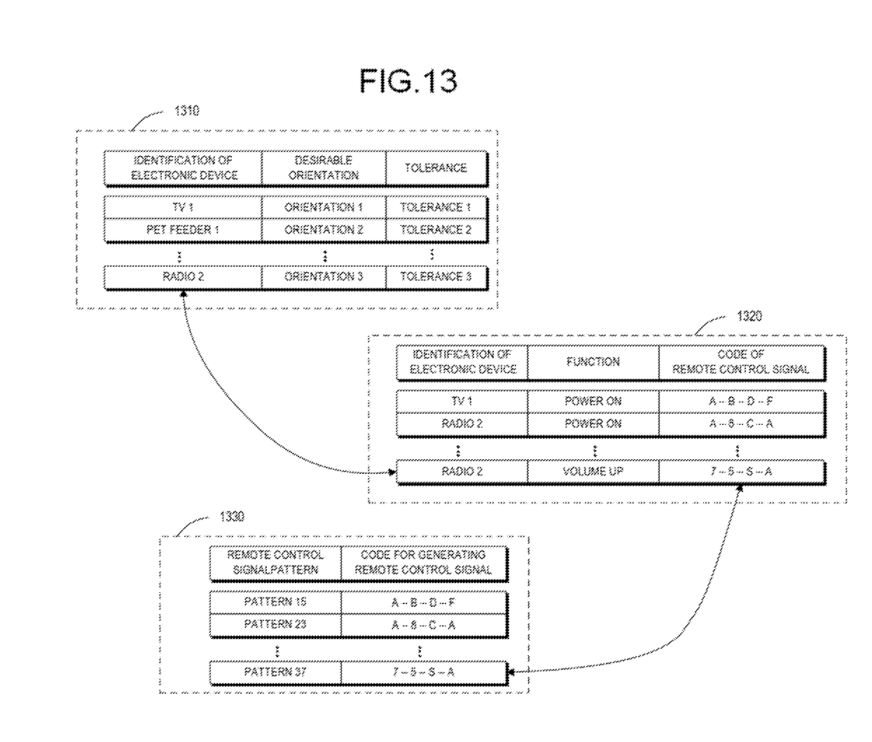

FIG. 13 illustrates a data structure according to an embodiment of the present invention. Referring to FIG. 13, in a first data table 1310, identification of an electronic device, desirable orientation for the electronic device, and tolerance of the orientation are associated to one another. In a second data table 1320, identification of electronic device, function of electronic device, and a code representing a remote-control signal for controlling the function are associated to one another and stored in the same data entry. The first data table 1310 and the second data table 1320 are associated by a common data (identification of electronic device). In a third data table 1330, remote-control signals and codes representing the remote control signals are associated each other and are stored in the same data entry. The second data table 1320 and the search data table 1330 are associated by a common data (codes for generating remote control signal).

### Additional Embodiments

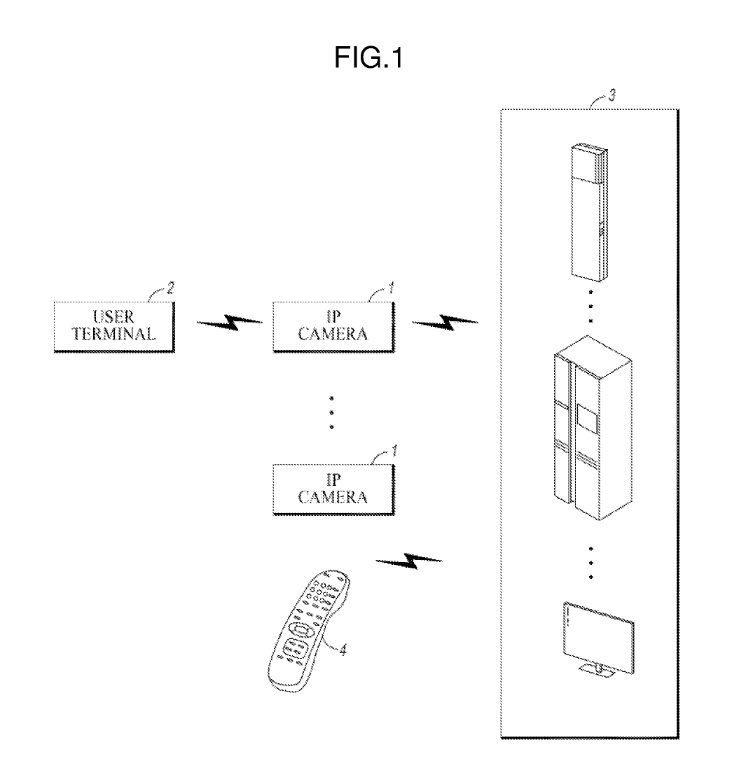

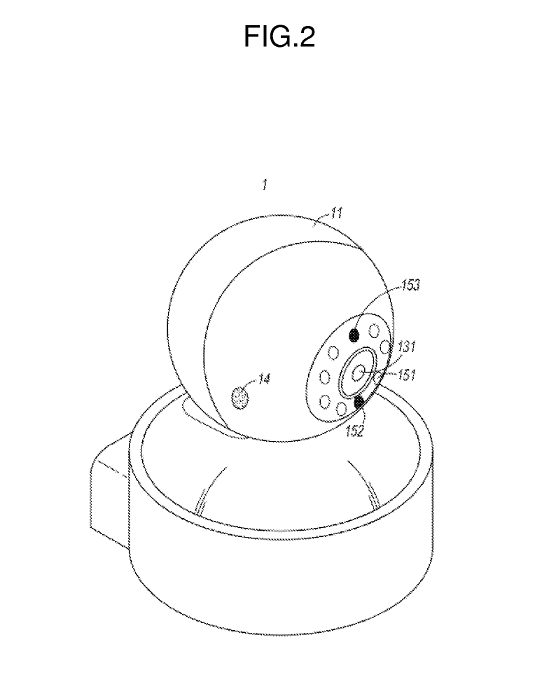

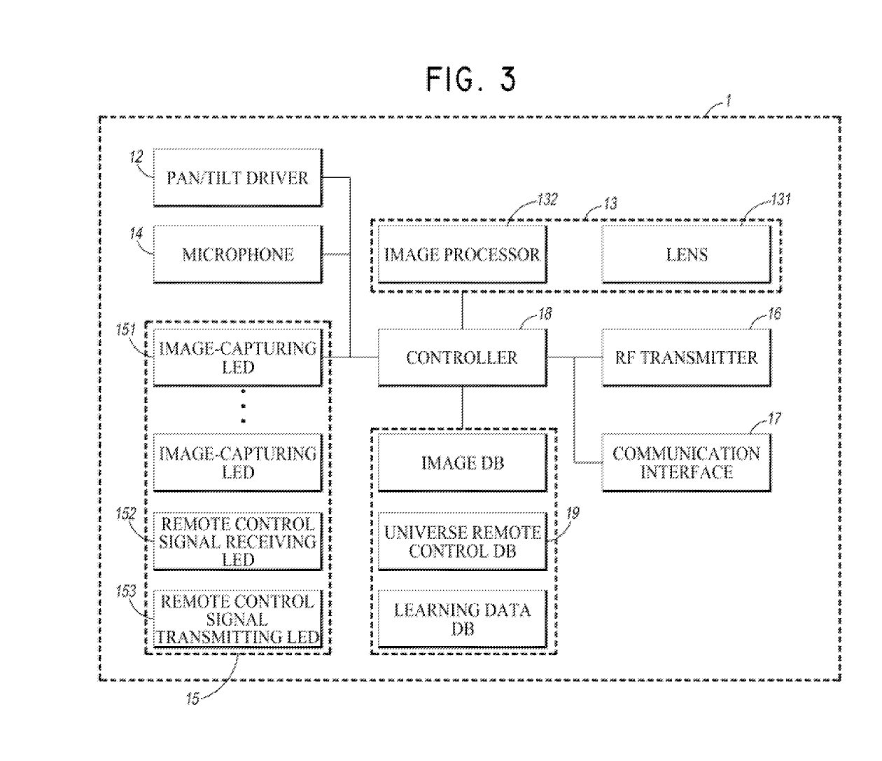

FIG. 1 illustrates a configuration of an IP camera system employing a wireless remote controlling function according to an embodiment of the present invention; FIG. 2 is a perspective view of the IP camera of FIG. 1, and FIG. 3 illustrates a configuration of the IP camera of FIG. 1.

Referring to FIGS. 1 to 3, the IP camera system employing a wireless remote controlling function according to an embodiment includes a plurality of IP cameras 1, a user terminal 2, a plurality of electronic devices 3 and a remote control 4.

The IP cameras 1 acquires image data of surroundings of the IP cameras 1 from a location where the IP cameras are installed transmit the acquired data to the user terminal 2 or send out a control signal to control the electronic devices 3 in response to an external control signal, and learn and store information to control the electronic devices 3 according to a user setting.

When requested by the user terminal 2 to capture image in real-time, the IP cameras 1 provide the current real-time image to the user terminal 2, or compress and store a captured image in a memory 17 and provide the compressed image to the user terminal 2 upon being requested by the user terminal 2.

IP camera 1 includes a body 11, a pan/tilt actuator 12, an image acquirer 13, a microphone 14, an LED 15, an RF transmitter 16, a communication interface 17, a controller 18, and a database 19.

The body 11 is installed such that operation of the pan/tilt actuator 12 is controlled in accordance with an externally-received control signal or an operation signal received from an operation unit which is separately installed on the body 11.

The image acquirer 13 is provided to acquire image data of surroundings of the body 11 and includes a lens 131 provided on a front surface of the body 11 as well as an image processor 132 configured to receive the light entering through the lens 131 and generates an image with an image processing method.

The microphone unit 14 is provided to acquire, from an audio signal, operation status, volume, location or direction of the electronic device, or presence, location or direction of a person, or the like, and to trace a sound source by calculating direction and distance of the sound source based on intensity, phase difference, and time associated with the sound source detected through two microphones. Each microphone employs a bi-directional microphone that has directivity to a specific direction, rather than an omni-directional microphone.

The LED module 15 includes a plurality of LEDs 151 for image capturing, a LED 152 for receiving remote control signal, and a LED 153 for transmitting remote control signal. The LED 153 (IR emitter) is fixed to the body 11 of the camera in a way that the LED 153 faces substantially same direction with the lens 131. As such, viewing angle of the lens 131 can represent signal transmission range of the LED 153. While the camera can process a captured images to identify IR remote control signal from an external remote control 4, the camera can include a separate commercialized module (IC) to receive/recognize IR control signal from the external remote control 4 as image processing to identify IR signal may cost a significant computing powers.

The plurality of LEDs 151 for image-capturing is arranged in an annular fashion around the front lens 131 of the body 11. The plurality of LEDs 151 for image-capturing do not operate when it is bright enough to meet the required level of illumination for image capturing, while the LEDs 151 operate when it is dark at night (i.e. when the required level of illumination for image capturing is not met) to allow infrared image capturing to be performed.

The LED 152 for receiving remote control signal is provided for a remote-controlling-function-learning process (to be explained below) in which when the user presses a key on the remote control 4, the LED 152 for receiving remote control signal receives an infrared signal sent from the remote control 4. The LED 153 for transmitting remote control signal is configure to transmit an infrared signal to control the operation of a corresponding electronic device 3 in accordance with a received control signal, when the control signal is received from the user terminal 2.

Meanwhile, not all the electronic devices used at home are infrared-controllable. For example, it is not possible to infrared-control a digital door lock as the digital door lock is only controllable with an RF signal. Accordingly, an aspect of the present invention additionally includes an RF transmitter 16, which sends out an RF signal to control the electronic devices 3 that react exclusively to the RF signals. Meanwhile, unlike the infrared signal, the RF signal does not have directivity. Accordingly, the install location of the RF transmitter 16 is not limited, and may be any place inside or outside the body 11 of the IP camera 1. In certain embodiments of the present invention, the camera 1 includes an IR emitter for generating a remote control signal for controlling target devices 3.

The communication interface 17 is provided for data transmission and reception with the user terminal 2, and for control of the electronic devices 3 by a wired or wireless method other than an infrared method, and includes a wireless communication module and a wired communication module.

In response to a control signal received from the user terminal 2, the controller 18 controls orientation (pan/tilt angle) of the IP camera 1 or operation of the electronic devices 3, based on a previously configured information in the memory 17 and in accordance with the control signal.

In addition to the image DB 191 for storing captured images, the database 19 includes a universe remote control DB 192 and a leaning data DB 193 for storing information necessary for the control of the electronic devices 3. In certain embodiments of the present invention, the database 19 can store association among identification of a target electronic device, a target function of the target device, a code representing a remote control signal for controlling the target function, and a desired orientation of the RF transmitter (or LED 153) for generating the remote control signal. The camera can retrieve, using the stored association in database 19, the desired orientation and/or the code in response to a control command from the user terminal for controlling the target function of the target electronic device.

The universe remote control DB 192 stores control signal information corresponding to manufacturer's information, product information, and remote control menu of the control target electronic device for facilitating the remote-control-signal-learning process. That is, the universe remote control DB 192 enhances learning convenience, as the universe remote control DB 192 allows the user to select and store only wanted menu icons from the remote control menus displayed on a screen rather than to operate through all the menu buttons of the remote control to set the information. The information on the universe remote control is accessible to the user terminal 2 through a webpage or downloadable via an application.

The learning data DB 193 stores remote control signal information of the respective electronic devices and pan/tilt control information (orientation control information) of the IP cameras, location information of the IP cameras and the electronic devices, or the like.

That is, in order to control each electronic device, different infrared signals are used depending on manufacturer's product models and supported functions. Further, because infrared signal has directivity, the control signal is limited to a predetermined range of angles. Accordingly, to ensure effective control on the control target electronic device, it is necessary to store pan/tilt information of the IP camera which can place the electronic device within the infrared signal reception range as well as to store the control signal information that matches the respective electronic devices.

To that end, the user can have remote control signal information corresponding to the remote controlling functions of the electronic device stored in the universe remote control DB 192 as well as the IP camera pan/tilt information to be learned and stored in in the learning data DB 193. the user can have remote control signal information acquired by manipulation of menu buttons on remote control of the electronic device as well as the pan/tilt information to learned and stored in the learning data DB 193. The method for remote-control-learning will be explained in detail below.

Meanwhile, the user terminal 2 connected to the IP cameras 1 by a wired or wireless communication network externally controls the operation of the IP cameras 1 and plays a role of monitoring the images captured through the IP cameras 1 at a remote distance. The user terminal 2 may be a portable terminal such as a smartphone, a laptop computer, or a desktop PC.

To be specific, the user terminal 2 may externally control the pan/tilt of the IP cameras 1 in response to a user's operation signal to change the direction of image capturing when the user wants to monitor an image in certain direction, or may input learning information required for controlling of the electronic device 3, or may transmit a control signal in accordance with the user's operation signal to the IP cameras 1.

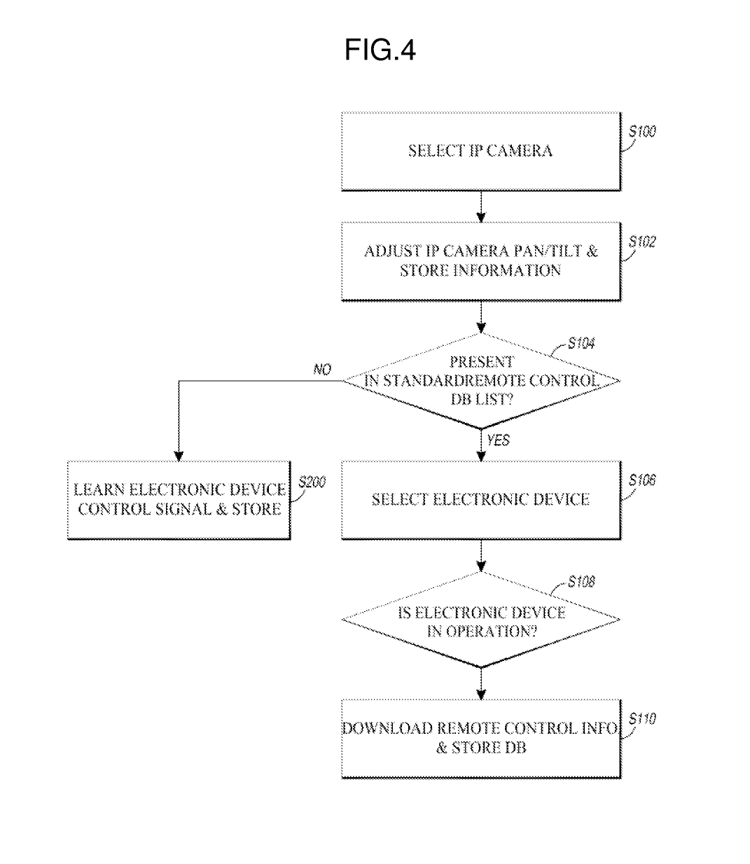

FIG. 4 is a flowchart provided to explain a learning method of an IP camera system employing a wireless remote controlling function according to an embodiment of the present invention. The learning method will be explained below with reference to FIGS. 1 to 3.

First, with the user terminal 2 the user executes an IP camera control program and selects a remote control registration menu.

Accordingly, a list of IP cameras 1 appears on the screen and the user selects an IP camera 1 to control the electronic device 3 intended for learning (S100). the user adjusts the pan/tilt of the selected IP camera 1 while viewing the images displayed on a screen of the user terminal 2, and when completing adjusting the pan/tilt, stores the pan/tilt information by matching it with the ID of the corresponding electronic device 3 (S102). The pan/tilt adjustment needs to be done in a way that the transmission range of the infrared signal of remote control signal transmitting LED 153 with directivity of the IP camera is aligned with the angle of infrared light reception of the electronic device and that image information and sound information for monitoring of the operational status of the electronic device 3 can be received.

It is determined if the corresponding electronic device 3 is in a list of the universe remote control DB 192 (S104), and if so, the corresponding electronic device 3 is selected from the list (S106). The screen may display the product model of the electronic device or the manufacturer, thus allowing the user to select the product model and the manufacturer in an order. Selecting the electronic device 3 may be directly done by the user from the list or, rather than direct selecting, an alternative embodiment may acquire the shape of the electronic device with the camera and automatically identify and select the model of the electronic device based on the acquired shape information.

After selecting the electronic device 3 from the list, the user presses one of the icons displayed on the screen, and when noting the corresponding electronic device to be in power-on/off state or to be in operation (S108), the user causes downloading and storing of the remote control information by matching it with the IP camera information and the IP camera pan/tilt information acquired at S100 and S102 (S110).

Meanwhile, when it is determined that the corresponding electronic device 3 is not present in the list of the universe remote control DB 192 at S104, while the user operating the remote control the remote control signals can be learned, via the IP camera, and stored.

The process of the learning and storing involves the user inputting information about the electronic device using a keypad screen, step-wise learning of control signals that match the remote control menus of the corresponding electronic device, and storing the control signals. The information of the electronic device may include product information and manufacturer information which may be directly inputted in a text form by the user or selected by the user from a list.

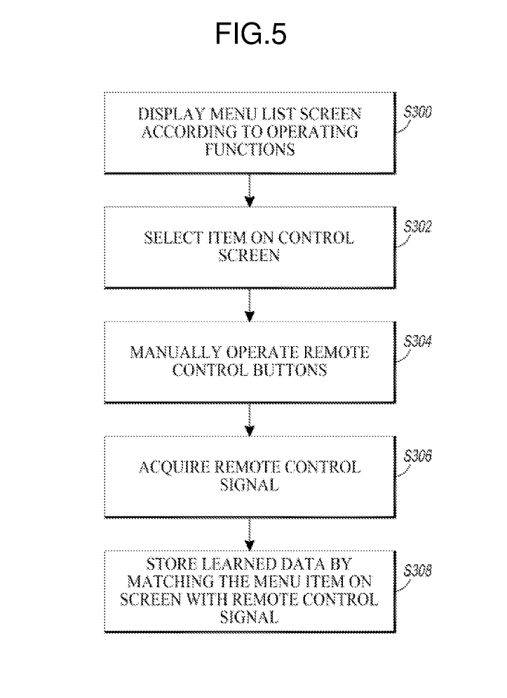

FIG. 5 is a flowchart illustrating a method of learning electronic-device remote-control information and registering the learned data according to a first method of the present invention.

First, when a product of the electronic device is selected, a menu list corresponding to the operational functions of the corresponding electronic device is displayed on a screen (S300).

Then, the user selects a necessary item from the menu list on the screen (S302), and presses a menu button of the remote control 4 that matches the corresponding item toward the IP camera 1 (S304).

As an infrared signal of the remote control 4 is received at the LED for receiving remote control signal 152 of the IP camera 1, a remote control signal for learning is acquired by the IP camera (S306). The acquired remote control signal can be processed, by the IP camera or an external computing device, to generate a code representing the acquired remote control signal. The code includes information that can be used to generate a corresponding remote control signal at the RF transmitter or at LED 153.

When the remote control signal for learning is acquired at the step S306, the user cause storing of the learned data by matching the item on the screen (S308).

After that, the operation from the step S302 to the step S308 are repeated until learning of the desired menu item is completed.

According to the first learning method of the present invention, the learning process can be simplified since the user does not have to input the remote control menu items one by one as text.

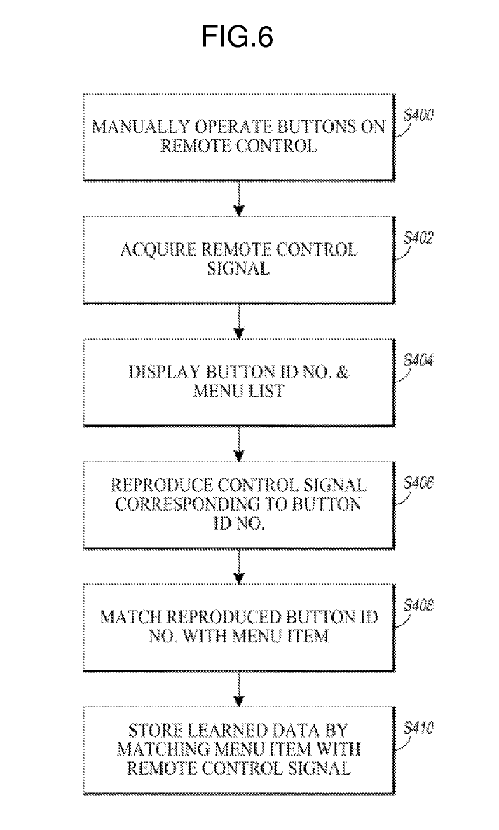

FIG. 6 is a flowchart illustrating a method for learning electronic-device remote-control information and registering the learned data according to a second method of a present invention.

First, when the user presses the remote control button toward the IP camera (S400), a remote control signal for learning is acquired as an infrared signal of the remote control 4 is received from the LED 152 for receiving remote control signal of the IP camera 1 (S402). At this time, the user presses all the buttons on the remote control 4 in order, so that all the remote control signals for learning can be acquired.

The remote control menu list necessary to drive the corresponding electronic device appears on the screen along with a button identification number (ID No.) (S404).

Then, as the user presses the button ID Nos. on the screen in order, thereby reproduces control signals and then identifies type of the control signals based on operational status of the electronic device (S406), and matches the button ID Nos. with menu items, respectively (S408). For example, when the user identify power-on/off in case No. “2” code (given an ID No.) was selected; the user may drag and match the ID No. “2” code to the “power” item. Accordingly, the infrared signal generated by pressing ID No. “2” matches with the “power” item, which simplifies the learning data setting as the user is not required to input the text information about the remote control menu item.

When matching the button ID Nos. and the menu items is completed, the learned information that matches (associates) the items on the screen and the remote control signals is stored (S410).

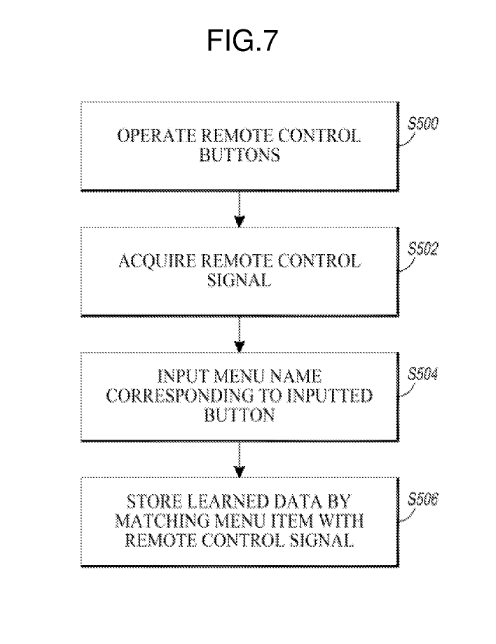

FIG. 7 is a flowchart provided to explain a method for learning electronic-device remote-control information and registering the learned data according to a third method of a present invention.

First, when the user presses a remote control button toward the IP camera (s502), a remote control signal for learning purpose is received via the remote control signal receiving LED 152 of the IP camera 1.

When, the user terminal 2 receives a remote control signal for learning from the IP camera 1 (S502), the user inputs a menu name so that the user can identify information about the function that corresponds to the pressed remote control button (S504). Although the operating the remote control button is performed prior to inputting a menu name, in another embodiment it is possible to input the menu name and to operate the remote control button subsequently.

When operating the button on the remote control and inputting menu names are completed, learning is completed and the learned data of matching between the items on the screen and the remote control signals is stored (S506).

Herein below, a method for controlling an electronic device at an IP camera system employing a wireless remote controlling function according to an embodiment of the present invention will be explained.

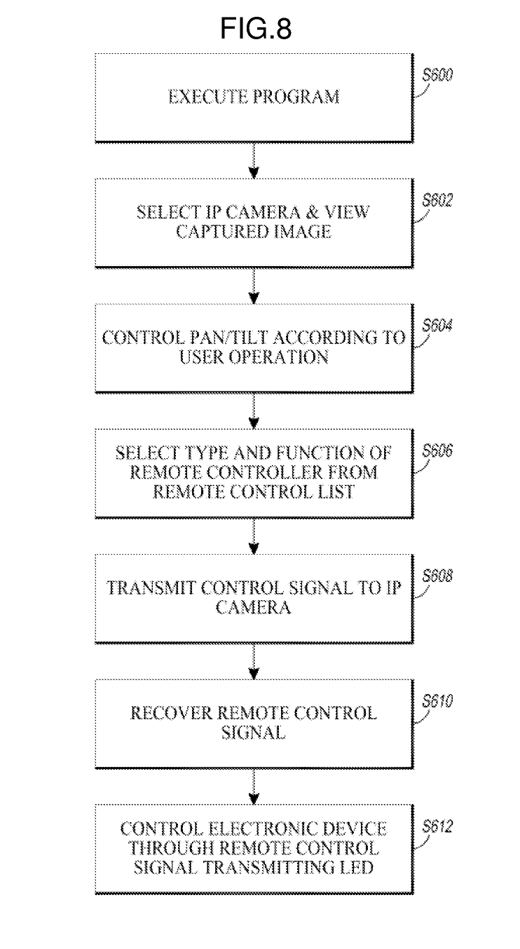

FIG. 8 is a flowchart provided to explain a method for controlling an electronic device at an IP camera system that employs a wireless remote controlling function according to a first embodiment of the present invention. Accordingly, embodiments will be explained below with reference to FIG. 8, along with FIGS. 1 to 3.

Referring to FIG. 8, first, an IP camera list appears on a screen as the user executes an electronic device control program (S600), and the user selects an IP camera and an image captured through the IP camera is displayed on the screen (S602).

At this time, the user terminal displays the operational status of the electronic device on a screen thereof as well as image information about the electronic device. The operational status of the electronic device may be recognized based on light emitting status of a display panel provided in the electronic device or a manufacturer name or a product name appearing on the image, or in the case of a TV or an audio equipment, based on the audio information inputted through a microphone provided in the IP camera 1.

It is possible to automatically recognize the currently-operated electronic device before the user selects an IP camera, and, in order to do so, relative location information between the IP cameras and the electronic devices or shape information needs be set in advance. That is, it is necessary to identify the electronic device in order to detect the operational status of the electronic device based on the panel light emitting status or audio information of the electronic device and notify the operational status of a corresponding electronic device. Accordingly, the embodiments of the present invention set in advance the shape information of the electronic devices, extract shape of the electronic device from the image acquired through the IP camera, and identifies the type of the electronic device by matching patterns between the extracted shape and preset shape information. Alternatively, it is possible to calculate distance between the IP camera and the electronic device and locations based on the audio information generated from the electronic device and identify the electronic device by matching the calculated result with the preset location information.

Meanwhile, while observing the screen of the user terminal 2, the user adjusts pan/tilt of the IP camera 1 so that the remote control transmitting LED 153 is directed toward the electronic devices 3 (S604).

When the pan/tilt adjustment of the IP camera 1 is completed, the electronic-device-remote-control menus are displayed on the screen. The user selects a desired remote control from the displayed list and selects a desired function from the menu list of the remote control (S606).

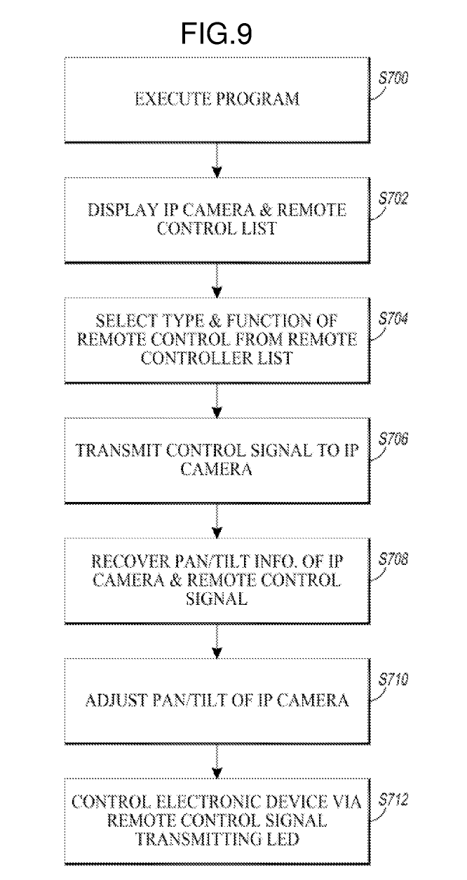

In one embodiment, the user may select a remote control from the screen of the user terminal, but not limited thereto. That is, selecting a remote control may be performed automatically. Accordingly, when the IP camera 1 is selected, the IP camera 1 captures images of the electronic devices within a recognition range, and the user terminal 2 may automatically identify the electronic devices based on the manufacturer names or product names marked on the electronic devices from the captured images, or may extract shape information of the electronic devices, match patterns between the extracted shape information and preset shape information, and automatically identify the electronic device so that the remote controls corresponding to the electronic devices are automatically selected. This automatic selecting of a remote control may be equally applicable to not only the first embodiment of FIG. 9 but also the second embodiment of FIG. 10.

The user terminal 2 sends out the inputted signal to the IP camera 1 (S608), and the IP camera 1 recovers the stored remote control signal from the database based on the received control signal (S610).

After that, the IP camera 1 transmits the remote control signal to the electronic device 3 via the remote control signal transmitting LED 153 to thus control the operation of the electronic device 3 (S612).

FIG. 9 is a flowchart provided to explain a method for controlling an electronic device at an IP camera system employing a wireless remote controlling function according to a second embodiment of the present invention. Accordingly, embodiments will be explained below with reference to FIG. 9, along with FIGS. 1 to 3.

Referring to FIG. 9, first, as the user executes an electronic device control program (S700) a list of IP cameras and a list of remote controls are displayed on a screen (S702).

After that, the user selects a desired remote control from the displayed list and also selects a desired function from a menu list of the remote control (S704).

The user terminal 2 sends the inputted signal to the IP camera 1 (S706), and the IP camera 1 recovers the IP camera's desirable orientation (pan/tilt information) and the remote control signal from the database based on the received control signal (S708).

The pan/tilt information (orientation information) of the IP camera 1 may be previously determined for individual control target electronic devices or may be calculated based on preset relative positions or angle information between the IP camera 1 and the electronic devices 3.

The IP camera 1 automatically adjusts the pan/tilt according to the recovered pan/tilt information (S710), and sends out a remote control signal via the remote control signal transmitting LED 153 to the electronic devices 3 to thus control operation of the electronic devices 3 (S712).

The pan/tilt information of the IP camera 1 may be controlled according to predetermined information, but in another embodiment it is possible to detect, in real-time, the location of the control target electronic device and calculate the pan/tilt information based on the detected location.

Accordingly, it is possible to obtain the location of the electronic devices and angle information between the electronic devices and the IP camera by acquiring sound signals outputted from the control target electronic devices through two microphones and by calculating direction and distance between the IP camera and the electronic devices based on the intensity and phase difference or time regarding sound source detected by two microphones.

Accordingly, pan/tilt information of the IP camera for controlling electronic devices can be obtained without setting pan/tilt information of the IP camera corresponding to the control target electronic devices or location information of the electronic devices in advance.

Moreover, the embodiments of the present invention may additionally include a method for automatically adjusting pan/tilt of the camera based on the location and distance information between the electronic devices and the IP camera when an error in the pan/tilt information is accumulated due to change deliberately made in the pan/tilt of the camera or repetition of the operation.

It will be appreciated by those skilled in the art that all of the functions described in this disclosure may be embodied in software (programs) executed by one or more physical processors of the disclosed system 160. The software may be persistently stored in any type of non-volatile storage.

Conditional language, such as, among others, “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art. It will further be appreciated that the data and/or components described above may be stored assume in a computer-readable medium and loaded into memory of the computing device using a drive mechanism associated with a computer readable storage medium storing the computer executable components such as a CD ROM, DVD ROM, or network interface. Further, the component and/or data can be included in a single device or distributed in any manner Accordingly, general purpose computing devices may be configured to implement the processes, algorithms, and methodology of the present disclosure with the processing and/or execution of the various data and/or components described above.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A camera apparatus comprising:
an Internet module configured to communicate with at least one device connected to the Internet;
a camera module comprising a lens and configured to capture images received through the lens;
a remote control module comprising an infrared (IR) emitter configured to emit IR beams for controlling one or more electronic devices;
an orientation module configured to change the IR emitter's orientation relative to the one or more electronic devices; and
a memory configured to store data for use in controlling the one or more electronic devices,
wherein the camera apparatus is programmed for setting up a remote control feature for a first electronic device, in which:
to determine a first orientation for use in orienting the IR emitter toward the first electronic device,
to store, in the memory, the first orientation in association with the first electronic device, and
to store, in the memory, a first code corresponding to a first IR beam pattern in association with either or both the first electronic device and the first orientation, wherein the first IR beam pattern is for controlling a first function of the first electronic device,
wherein the camera apparatus is further programmed for executing the remote control feature, in which:
to retrieve the first orientation and the first code from the memory in response to a first user command for controlling the first function,
to cause the orientation module to change the IR emitter's orientation to the first orientation, if needed, and
to cause the IR emitter to emit the first IR beam pattern corresponding to the first code.

2. The apparatus of claim 1, further comprising an IR receiver configured to receive the IR beam patterns from an external remote controller, wherein the camera apparatus is further programmed to learn the first IR beam pattern when the IR receiver receives the first IR beam pattern while the remote control feature is being set up for the first electronic device, wherein upon receipt of the first IR beam pattern, the camera apparatus is configured to process the received first IR beam pattern for generating the first code to store in the at least one data entry in association with the first electronic device or the first orientation.

3. The apparatus of claim 1, wherein the camera apparatus is configured to receive the first code corresponding to the first IR beam pattern from an external computing device connected via the Internet module.

4. The apparatus of claim 1, wherein the IR emitter and the camera lens are fixed in a single piece body and configured to change their orientation as the single piece body changes its orientation.

5. The apparatus of claim 1, wherein the camera apparatus is configured to send motion picture images captured by the camera module to a user interface installed on a computing terminal connected to the camera apparatus via the Internet module such that a user of the computing terminal can watch the motion picture images on the user interface.

6. The apparatus of claim 5, wherein the camera apparatus is configured to receive a control signal for changing the IR emitter's orientation from the user interface such that a user can control the IR emitter's orientation while viewing the motion picture images, wherein the first orientation is determined in response to the user's confirmation submitted on the user interface.

7. The apparatus of claim 1, wherein when the first orientation is determined, prior to associating with the first electronic device, the camera apparatus is further programmed to confirm that at the first orientation the IR emitter is aligned with the first electronic device such that the first electronic device responds to IR beam patterns emitted from the IR emitter.

8. The apparatus of claim 1, wherein the camera apparatus is configured to identify the first electronic device from an image captured by the camera module for initiating a setup mode for setting up the remote control feature therefor.

9. The apparatus of claim 1, wherein the camera apparatus is further programmed to determine if it is needed to change the IR emitter's orientation to the first orientation, wherein the camera apparatus determines that the IR emitter's orientation does not need to change when the IR emitter's current orientation is within a predetermined tolerance.

10. The apparatus of claim 1, wherein the camera apparatus is further programmed to determine if it is needed to change the IR emitter's orientation to the first orientation, wherein when the camera apparatus determines that the IR emitter's orientation needs to change, the camera apparatus is configured to cause the orientation module to change the IR emitter's current orientation to the first orientation or within a predetermined tolerance from the first orientation.

11. A remote control system comprising:
a user interface for installing on a computing terminal; and
the camera apparatus of claim 1 connected to the computing terminal via the Internet module such that the camera apparatus is configured to transmit motion picture images to the computing terminal for viewing via the user interface and that the camera apparatus is configured to receive user commands submitted via the user interface for controlling the camera apparatus.

12. The remote control system of claim 11,
wherein the camera apparatus further comprises an IR receiver configured to receive IR beam patterns from an external remote controller,
wherein the camera apparatus is further programmed to learn the first IR beam pattern when the IR receiver receives the first IR beam pattern while the remote control feature is being set up for the first electronic device, and
wherein upon receipt of the first IR beam pattern, the camera apparatus is configured to process the received first IR beam pattern for generating the first code to store in the at least one data entry in association with the first electronic device or the first orientation.

13. The remote control system of claim 11, wherein the camera apparatus is configured to receive the first code corresponding to the first IR beam pattern from an external computing device connected via the Internet module.

14. The remote control system of claim 11,
wherein the camera apparatus is configured to send motion picture images captured by the camera module to a user interface installed on a computing terminal connected to the camera apparatus via the Internet module such that a user of the computing terminal can watch the motion picture images on the user interface, and
wherein the camera apparatus is configured to receive a control signal for changing the IR emitter's orientation from the user interface such that a user can control the IR emitter's orientation while viewing the motion picture images, wherein the first orientation is determined in response to the user's confirmation submitted on the user interface.

15. The remote control system of claim 11,
wherein the camera apparatus is further programmed to determine if it is need to change the IR emitter's orientation to the first orientation, wherein when the camera apparatus determines that the IR emitter's orientation needs to change, the camera apparatus is configured to cause the orientation module to change the IR emitter's current orientation to the first orientation or within a predetermined tolerance from the first orientation.

16. A method of operating the camera apparatus of claim 1, the method comprising:
establishing a communication channel with a user terminal via the Internet module;
receiving a selection of the first electronic device from the user terminal;
receiving a confirmation of the first orientation from the user terminal;
storing, in the memory, the first orientation in association with the first electronic device;
receiving an selection of the first function from the user terminal;
storing, in the memory, the first code corresponding to the first function in association with the first electronic device;
subsequently, receiving the first user command for controlling the first function of the first electronic device;
in response to the first user command, retrieving the first orientation and the first code from the memory;
changing the IR emitter's orientation to the first orientation, if needed; and
emitting the first IR beam pattern from the IR emitter for controlling the first function of the first electronic device.

17. The method of claim 16, wherein the camera apparatus further comprises an IR receiver configured to receive the IR beam patterns from an external remote controller, wherein the method further comprising:
learning the first IR beam pattern when the IR receiver receives the first IR beam pattern while the remote control feature is being set up for the first electronic device; and
upon receipt of the first IR beam pattern, processing the received first IR beam pattern for generating the first code to store in the at least one data entry in association with the first electronic device or the first orientation.

18. The method of claim 16, further comprising
receiving the first code corresponding to the first IR beam pattern from an external computing device connected via the Internet module.

19. The method of claim 16, wherein the camera apparatus is configured to send motion picture images captured by the camera module to a user interface installed on a computing terminal connected to the camera apparatus via the Internet module such that a user of the computing terminal can watch the motion picture images on the user interface, wherein the method further comprising:
receiving a control signal for changing the IR emitter's orientation from the user interface such that a user can control the IR emitter's orientation while viewing the motion picture images, wherein the first orientation is determined in response to the user's confirmation submitted on the user interface.

20. The method of claim 16, further comprising determining if it is need to change the IR emitter's orientation to the first orientation, wherein when the camera apparatus determines that the IR emitter's orientation needs to change, causing the orientation module to change the IR emitter's current orientation to the first orientation or to an orientation within a predetermined tolerance from the first orientation.
